(19) United States
(12) Patent Application Publication
(10) Pub. No.: US 2004/0022267 A1
(43) Pub. Date: Feb. 5, 2004

(54) Adaptive bandwidth efficient intelligent multimedia networks toward future generation wireless gigabit LANS

(75) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/210,841

(22) Filed: Jul. 31, 2002

(51) Int. Cl. H04J 3/16

(52) U.S. Cl. 370/468; 370/477

(57) ABSTRACT

An adaptive bandwidth device for a Local Area Network includes: a programmable bandwidth RF/IF unit containing at least one operating range of Quality of Service (QoS) values; a baseband processing parameter selection unit for selecting parameters within said at least one operating range in the programmable bandwidth RF/IF unit; a D/A and A/D conversion unit for converting analog and digital communication between the programmable bandwidth RF/IF unit and said baseband processor parameter selection unit; and a transmitting and receiving unit for transmitting and receiving communications with at least one other device via a reconfigurable communication medium; wherein the baseband processing parameter selection unit selects operating parameters after evaluating an operating range of said at least one other device, and a data capacity and traffic volume of said reconfigurable communication medium. A system and method includes exchanging information regarding operating parameters of the devices, and the devices either self-adjust, or are instructed to change operating parameters according to LAN needs.

### BACKGROUND OF THE INVENTION

1. Field of the Invention

The present invention is related to communication systems and the bandwidth required for communication at a certain level of Quality of Service (QoS). More particularly, the present invention is related to the optimization of available bandwidth and the increase in bits/Hz of available channels of communication.

2. Description of the Related Art

There are an ever-increasing number of electronic devices requiring networking, and the lack of abundant communication bandwidth has increased the need to develop bandwidth efficient communication systems.

There has been significant attention paid to techniques that attempt to utilize bandwidth more efficiently than techniques of previous generations. For example, Frequency Hopping, CDMA with power control, 802.11a and HIPERLAN 2 with adaptive coding schemes, ADSL, and the Japanese DTV standard (ISBT) are just a few examples of attempts to utilized bandwidth more efficiently. Furthermore, the recently adopted Homeplug Alliance power-line communication specification is yet another example of a system where multiple carriers are selective dropped out to maintain a given QoS. In addition, there has been work performed on adaptive modulation and space-time coding, in the effort to maximize the efficiency of bandwidth.

However, as more and more application continue to compete for a given bandwidth in an environment such as the home, it will become ever more difficult to maintain adequate QoS criteria (such as data-rate, bit error rate, real-time streaming) so as to insure the multi-media content delivery across devices. In addition, the typical home network must support overall data-rate in the gigabit range. Thus, there is a need to develop techniques to optimally utilize the available bandwidth and increase the bits/Hz of the available channel.

### SUMMARY OF THE INVENTION

An aspect of the present invention is to provide a method and apparatus for optimally using available bandwidth by adjusting the transmission parameters to suit the application needs and the capacity of the receiving devices over the entire network in a “co-operative” interactive manner. The parameters adjusted include both source and channel coding, and each device and application considers the requirements of other devices in the network when adjusting the transmission parameters.

### BRIEF DESCRIPTION OF THE DRAWINGS

FIG. 1 is an illustration of a configuration of two devices communicating to each other via a reconfigurable medium.

FIG. 2 is an illustration of the allocation of the bandwidth resource to different applications in accordance with the needs of the applications and the sub-channel capacity in a frequency selective wide-band fading channel.

FIG. 3 is a flowchart providing an overview of a method according to the present invention.

### DETAILED DESCRIPTION OF THE INVENTION

The following explanation is provided for purposes of illustration, not for limitation, and it is understood by persons of ordinary skill in the art that there are various modifications that may be made which would be within the spirit of the invention and scope of the appended claims.

With regard to the techniques employed to optimize bandwidth use by co-operation among the devices, in a first aspect of the invention, for example, a small-screen video display has the capability to operate optimally a certain bit-rate, but the display can operate adequately at a lower bit-rate so as to free up bandwidth for other applications.

If the traffic is considered to be moderate or heavy, the display device will request a low data-rate transmission. On the other hand, if the traffic is light, the display may request a higher data-rate of transmission.

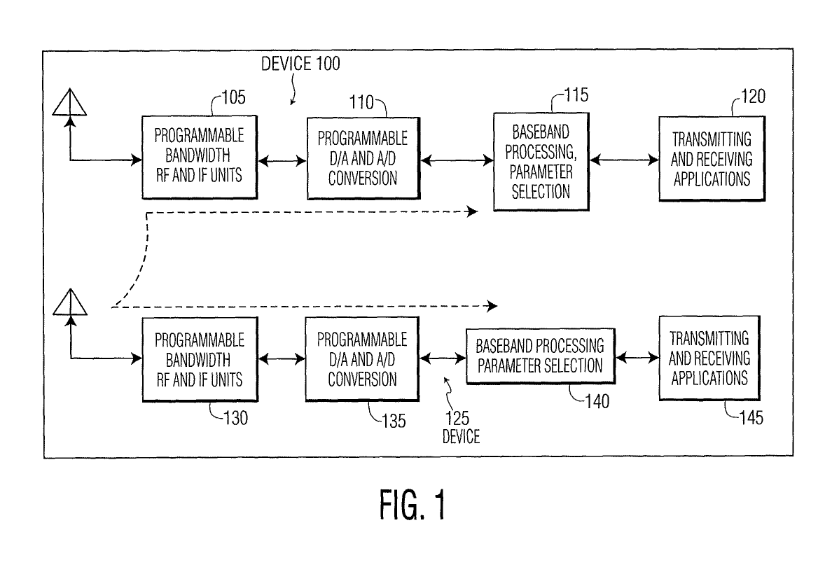

For example, FIG. 1 illustrates device 1 and device, 100 and 125, respectively, which communicate with each other via a reconfigurable medium. The first and second devices comprise a programmable bandwidth RF and IF unit 105, 130 a programmable D/A and A/D conversion unit 110, 135, a baseband processing unit for parameter selection 115, 140 and a unit for transmitting and receiving applications 120, 145, respectively according to the parameters selected by the respective baseband processing parameter selection unit.

In this aspect of the invention, the programmable bandwidth RF and IF unit 105, 130 is programmed with a range of transmission parameters for selection by the baseband processing parameter selection unit 115, 140 via a D/A or A/D conversion 110 depending on the direction of the communication. Portions of the range can, for example, be identified as “adequate”, “satisfactory” and “optimal”. It should be understood that these terms have been chosen for explanatory purposes, and there could be few portions or more portions, depending on a desired QoS. For example, an “adequate” transmission parameter would be the lowest bit-rate that a manufacturer deems that device 1 can be operable.

Alternatively, or in addition thereto, adequate parameters may include a marginally acceptable data-rate, bit error rate, and/or rate of real-time streaming, just to name a few examples. Thus, parameter selection may also take into account the particular requirements for individual applications so that the actual transmitting and receiving of applications by units 120,145, may, for example, require device 1 or 2 to operate at QoS that is somewhat higher than the “adequate” level. For example, if device 1 is a display, a particular graphical program or video stream may require a higher QoS than if the display were being used for a word processing program.

Device 2 would have requirements that could be identical to device 1, or might require more stringent or less stringent parameters. Device 1 and device 2 may exchange parameter information with each, or this information could be provided by a network program.

The parameters selected would also be based on the data traffic. In one aspect of the invention, the devices may have a default of optimal parameters. The baseband processing section 115, 140 would periodically monitor data traffic (or receive this information from the network program) and along with the information regarding the parameters of the other device or devices, the device would select transmission parameters at a point in the range that would not overload the network.

In the case that a lower data-rate transmission is requested by the display device, it is possible that more stringent coding techniques may be required and tighter QoS requirements (for example, changing the bit error rate, or speed of real-time streaming). Thus, the transmitter has to be able adjust the parameters of both source coding and channel coding to guarantee the delivery of content, yet still be able to free-up bandwidth for use by other applications and/or devices.

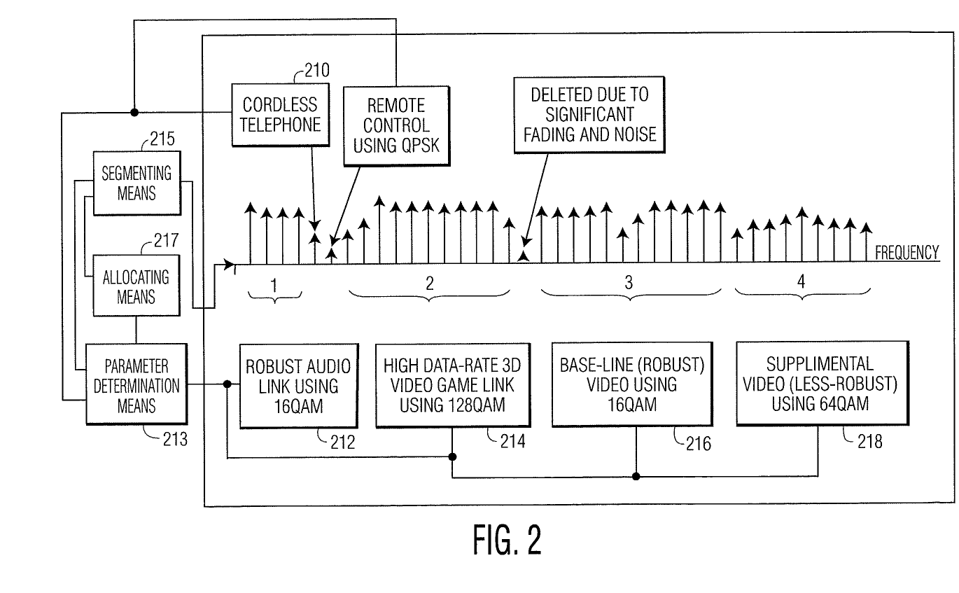

In another aspect of the present invention, in the case where a channel is subdivided into sub-bands, and when devices communicate to each other, they allocate the sub-bands according to the different streaming multi-media contents, such as audio and base line video transmitted through the robust channel, and non-critical content through a non-robust channel in accordance with the QoS requirement of the respective content. Operating means 213 (shown in FIG. 2) determines the operating parameters for a plurality of devices attached to the link.

FIG. 2 illustrates yet another aspect of the present invention, wherein a cordless telephone 210 (and/or other audio devices) communicates through a portion of a channel, and video game devices communicate through the rest of the channel. In this case, the bandwidth can be segmented by segmentation means 215 into sub-bands (sub-bands 1-4 shown for explanatory purposes, there can be fewer or far greater numbers of sub-bands), with parameters for each sub-band then being adjusted and assigned to different devices to optimize the overall bandwidth utilization of the devices in the network.

As shown in FIG. 2, a robust audio link 212 using 16 QAM is allocated via allocation means 217 the sub-band 1. Sub-band 2 is allocated to a high data-rate 3D video game link 214 using 128 QAM. Sub-band 3 is allocated to a base-line robust 216 video using 16 QAM. Finally, sub-band 4 in this example is allocated to a supplemental video (less robust) 218 using 64 QAM. The network will then operate in both a time and frequency multiplex system, with the sub-band allocation being made in accordance with the needs of the applications and the sub-channel capacity.

In still yet another aspect of the present invention, there can be an increase in the overall bits/HZ of the available bandwidth. A deeply faded sub-channel will be handled differently from a non-faded sub-channel. Power, coding, etc. will then be adjusted to optimize the overall performance of the network.

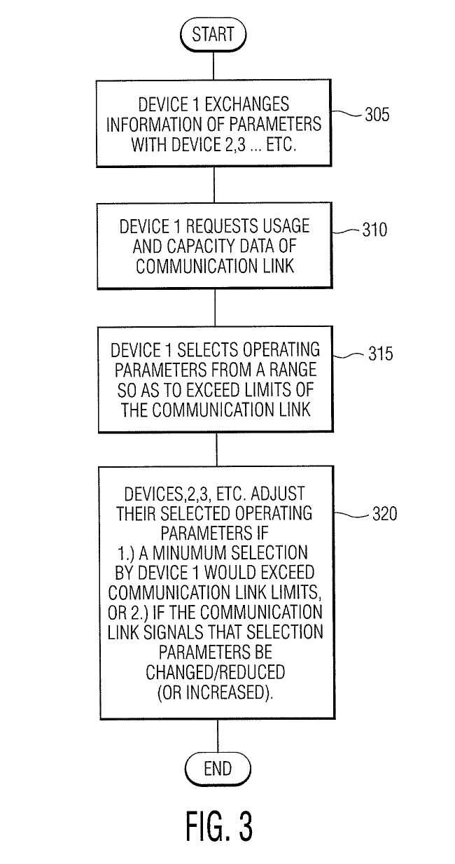

FIG. 3 provides a flowchart with a broad overview of one aspect of the present invention illustrated in FIG. 1.

At step 305, a first device (Device 1) exchanges parameter information with other devices regarding range of operability, bit rate, etc.

At step 310, the first device either requests usage and data capacity from the communication link (e.g. a network control program) or it may obtain these values from another device. Alternatively, the communication link may periodically provide the usage information in a general broadcast, or such information could also be provided periodically along with an exchange of data along the link.

At step 315, the first device selects (or signifies) the operating parameters to be used from a range of operational possibilities. Typically, a unit such as the baseband processing parameter selection unit 115 would select an operating point in the range that does not exceed capacity of the communication link and/or increase data traffic beyond a certain predetermined value. In essence, step 315 has at least two variations, the first is a selection of operating parameters, and another variation is the first device transmits the proposed operating parameters so that the other devices and/or communication link can make any necessary adjustments to their own parameters for operation. Ultimately, there should be some type of priority scheme where conflicts between devices can be resolved, or a network program may resolve any such conflicts and assign values to be used by the devices.

At step 320, the other device or devices may adjust their operating parameters if: (1) from the information exchange, it has been determined that the first device could not operate with the available traffic; or (2) the communication link instructs the device to reduce (or increase for that matter) its operating parameters.

While step 320 is optional, the interaction and adjustment of the other devices is desirable so that the newly added devices are permitted to operate at levels that are similar to previously connected devices on the communication link.

The algorithmic aspects of the present invention may include optimization of the physical layer of a wide-band system, for example, in excess of 100 MHz bandwidth using multi-carrier or sub-band (multi-hopping modulation. The following parameters can be changed to optimally use such a high bandwidth system in an optimal manner:

(1) sub-band encoding on both the receiver and transmitter side, optimum coding for sub-bands and algorithms to select capacity and the needs of the multi-media content;

(2) trade-offs among power, modulation order, modulation type (such as CDMA, QAM, OFDM), error-correction coding, pre-equalization, multi-media content encoding, and space-time coding;

(3) Pre-equalization;

(4) System Architectures to utilize adaptive sub-band channels as part of a wide-band network;

(5) Bandwidth efficient “co-operative” algorithms over the entire network;

(6) Techniques for multi-media traffic support, for example, guaranteed bandwidth; and

(7) Techniques to support low data rate devices that trade data rate for lower cost and power consumption.

Various modifications may be made by a person of ordinary skill in the art that does not depart from the spirit of the invention or the scope of the appended claims. For example, although the examples in FIG. 2 were described using QAM, CDMA, M-QAM or other carrier techniques may be employed. This would be especially true in the case of wide-band system having network requirements of high-bandwidth efficiency and real-time transfer leads to a choice of multi-carrier systems. A large bandwidth, such as 150 MHz in the 5-6 ISM band can be partitioned into sub-bands and appropriate parameters, then selected to obtain overall data-rates in the gigabit range with adequate QoS to meet the needs of applications/appliances in a given network.

As a small portable device receiving voice or base-line video may not require high data rates but need low-power dissipation to increase the life of the battery, it is preferable that the QoS for the devices be scalable. A scalable QoS with power dissipation to permit battery operation of many devices is desirable. Further, a variety of disciplines such as source encoding, channel encoding, communications design at the physical layer, MAC techniques and low power design are all desirable, and can be implemented in this invention.

What is claimed is:

1. An adaptive bandwidth device comprising:
a programmable bandwidth RF/IF unit containing at least one operating range of Quality of Service (QoS) values;
a baseband processing parameter selection unit for selecting parameters within said at least one operating range in the programmable bandwidth RF/IF unit;
a D/A and A/D conversion unit for converting analog and digital communication between the programmable bandwidth RF/IF unit and said baseband processor parameter selection unit; and
a transmitting and receiving unit for transmitting and receiving communications with at least one other device via a reconfigurable communication medium;
wherein the baseband processing parameter selection unit selects operating parameters after evaluating an operating range of said at least one other device, and a data capacity and traffic volume of said reconfigurable communication medium.

2. The adaptive bandwidth device according to claim 1, wherein the device and said at least one other device exchange operating parameter information.

3. The adaptive bandwidth device according to claim 1, wherein the adaptive bandwidth device and said at least one other device receive operating parameter information about each other from a network control program on the reconfigurable communication medium.

4. The adaptive bandwidth device according to claim 1, wherein the QoS values include at least one of data-rate, bit error rate, and real-time streaming rate.

5. The adaptive bandwidth device according to claim 1, wherein the baseband processing parameter selection unit periodically monitors a traffic volume of the reconfigurable medium, and selects updated operating parameters based on a change in traffic volume.

6. The bandwidth device according to claim 1, wherein the baseband parameter selection unit evaluates the traffic volume according to a ratio of one of MOPS (millions of operations per second) and MIPS (millions of instructions per second) in use to a predetermined capacity of the reconfigurable communication medium.

7. The bandwidth device according to claim 3, wherein the baseband processing parameter selection unit includes means for adjusting the operating parameters from an instruction received the network control program on the reconfigurable communication medium.

8. The bandwidth device according to claim 1, wherein the transmitting and receiving unit transmits and adjusts both source encoding and channel encoding according to available bandwidth.

9. The bandwidth device according to claim 1, wherein the transmitting and receiving unit transmits and receives using CDMA.

10. The bandwidth device according to claim 1, wherein the transmitting and receiving unit transmits and receives using M-QAM.

11. The bandwidth device according to claim 1, wherein the transmitting and receiving unit transmits and receives using OFDM.

12. The bandwidth device according to claim 1, wherein the baseband processing parameter selection unit evaluates power consumption requirements of the device for said at least one operating range.

13. An adaptive system for allocating bandwidth to various applications in a Local Area Network (LAN), comprising:
means for determining operating parameters of a plurality of devices;
means for segmenting available bandwidth into a plurality of sub-bands;
means for allocating at least a portion of one sub-band of the plurality of sub-bands to a first device, and a remainder to at least a second device.

14. The system according to claim 13, wherein the means for allocating includes means for determining Quality of Service (QoS) operating parameters of the first device and said at least a second device prior to apportioning said at least a portion of one sub-band.

15. The system according to claim 13, wherein the means for allocating periodically makes an allocation determination regarding an amount of said at least a portion of one sub-band to the first device depending on traffic volume on the LAN.

16. An adaptive system for allocating bandwidth to various applications in a Local Area Network (LAN), comprising:
means for determining operating parameters of a plurality of devices;
means for allocating at least one of a number of bits and frequency of available bandwidth to a first device, and a remainder to at least a second device, wherein said at least one of the number of bits and frequency of available bandwidth is periodically verified and reallocated according to a traffic volume on the LAN.

17. A Method for providing an adaptive bandwidth allocation among devices in a Local Area Network (LAN), comprising the steps of:
(a) exchanging operating parameter information between a first device and at least a second device over a reconfigurable medium of the LAN;
(b) evaluating a data capacity and traffic volume of the LAN;
(c) said first device selecting a plurality of operating parameters within an operating range for the first device, wherein the plurality of parameters selected in conjunction with said at least a second device do not exceed limits of the reconfigurable medium of the LAN.

18. The method according to claim 17, wherein said first device sends the selected operating parameters to at least one of the second device and the LAN for verification prior to being operational.

19. The method according to claim 17, further comprising:
(d) one of said first device and said at least a second device adjusting operating parameters so that said first device and said at least a second device do not in aggregate exceed limits of the reconfigurable medium of the LAN.

20. The method according to claim 17, further comprising:
(d) one of said first device and said at least a second device adjusting operating parameters so said first device and said at least a second device all respectively operate according to a predetermined level.

21. The method according to claim 17, wherein the adjusting in step (d) is performed after receiving an instruction from a network control program via the reconfigurable medium of the LAN.

22. The method according to claim 18, wherein the adjusting in step (d) is performed after receiving an instruction from a network control program via the reconfigurable medium of the LAN.

23. The method according to claim 17, further comprising:
(d) allocating an available bandwidth into sub-bands according to operating parameters of the first device and said at least a second device; and
(e) periodically monitoring the traffic volume on the LAN and Quality of Service (QoS) of the first device and said at least a second device.

24. The method according to claim 23, further comprising:
(f) reallocating at least a portion of the sub-bands according to the monitoring performed in step (e).
